(19) United States
(12) Patent Application Publication
(10) Pub. No.: US 2022/0001677 A1
(43) Pub. Date: Jan. 6, 2022

(54) DUPLEX PRINTING AND CONDITIONING BASED ON INK DENSITY

(71) Applicant: Hewlett-Packard Development Company, L.P., Spring, TX (US)

(72) Inventors: Jody L Clayburn, Vancouver, WA (US); Robert Matthew Yraceburu, Vancouver, WA (US); Stephen Thomas Rohman, Vancouver, WA (US); Matthew J. Raisanen, Vancouver, WA (US)

(73) Assignee: Hewlett-Packard Development Company, L.P., Spring, TX (US)

(21) Appl. No.: 17/295,019

(22) PCT Filed: Dec. 17, 2018
(86) PCT No.: PCT/US2018/066062

§ 371 Date: May 18, 2021

(51) Int. Cl. B41J 3/60; B41J 11/00

(52) U.S. Cl. CPC B41J 3/60; B41J 2203/01; B41J 11/0024

(57) ABSTRACT

Examples of duplex printing and conditioning based on ink density are described. In an example, an ink density for a first printed side and an ink density for a second printed side of a duplex page are determined. The duplex page is printed and conditioned based on a highest ink density of the first printed side and the second printed side.

### BACKGROUND

Printing devices may apply a print substance, which can include printing agents or colorants, to a printed media sheet such as paper. A printing device may include a black print substance and/or color print substances. In some examples, printing devices may perform duplex printing to print on both sides of a page. The printing devices may perform conditioning after printing a duplex page.

### BRIEF DESCRIPTION OF THE DRAWINGS

FIG. 1 is a block diagram of an example of a printing device that may be used for duplex printing and conditioning based on ink density;

FIG. 2 is a block diagram of an example of an apparatus that may be used in an example of a method for duplex printing and conditioning based on ink density;

FIG. 3 is a flow diagram illustrating an example of a method for duplex printing and conditioning based on ink density;

FIG. 4 is a flow diagram illustrating another example of a method for duplex printing and conditioning based on ink density;

FIG. 5 is a flow diagram illustrating another example of a method for duplex printing and conditioning based on ink density; and

FIG. 6 is a flow diagram illustrating yet another example of a method for duplex printing and conditioning based on ink density.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Printing devices—including printers, copiers, fax machines, multifunction devices including additional scanning, copying, and finishing functions, all-in-one devices, and pad printers to print images on three dimensional objects—apply a print substance, which can include printing agents or colorants, to a substrate. A substrate is a superset of print media, such as plain paper, and can include any suitable object or materials to which a print substance from a printing device is applied. For ease of explanation, a substrate is referred to herein as a “page.” Print substances, including printing agents and colorants, are a superset of inks and can include liquid inks, or other suitable marking material that may or may not be mixed with fusing agents, detailing agents, or other materials and can be applied to the substrate. For ease of explanation, a print substance is referred to herein as “ink.”

In some approaches, the print and conditioning speed of a duplex page may be determined independently and controlled based on the ink density for each side. These approaches may negatively impact print and/or page quality (e.g., waviness, curl, page-to-page friction), which may result in quality issues with a finisher component.

This disclosure relates to methods for printing and conditioning a page based on the ink density of both sides of a printed page. The type of printing (e.g., duplex or simplex printing) may be determined for a given page. If the page is a duplex page, then the ink density of each side of the page may be determined. If the ink density for the first printed side is greater than the ink density of the second printed side, then the second printed side may be printed and conditioned using the settings for the first printed side. Therefore, printing and conditioning of the duplex page may be based on the highest ink density of the two sides.

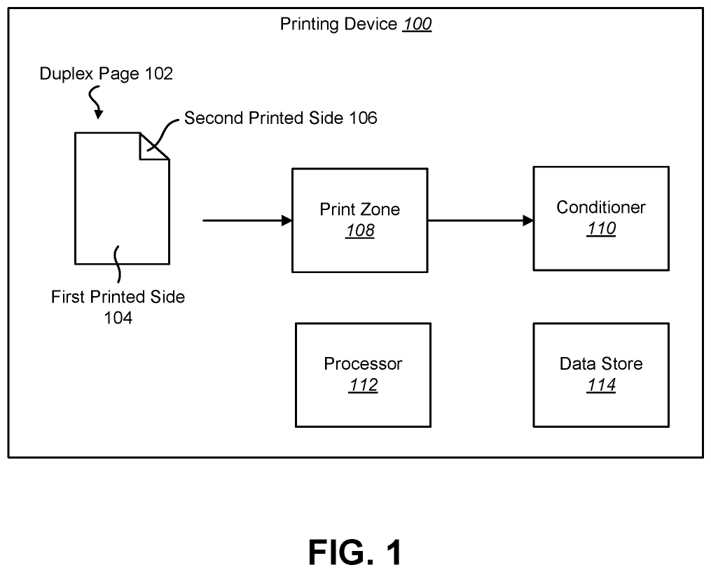

FIG. 1 is a block diagram of an example of a printing device 100 that may be used for duplex printing and conditioning based on ink density. The printing device 100 (e.g., a page wide inkjet printer) may print and condition a duplex page 102 based on the ink levels on the page 102.

The printing device 100 may include a processor 112. In some examples, the processor 112 may be a computing device, a semiconductor-based microprocessor, a central processing unit (CPU), a graphics processing unit (GPU), field-programmable gate array (FPGA), an application-specific integrated circuit (ASIC), and/or other hardware device. The processor 112 may be connected to other components of the printing device 100 via communication lines (not shown).

The processor 112 may control motors and/or actuators (not shown) to control operations of the components of the printing device 100. For example, the processor 112 may control a motor (not shown) that determines the speed of printing in a print zone 108. The processor 112 may also control actuators that control the deposition of ink on the duplex page 102. The processor 112 may also control actuators that control the feeding of ink into the printhead(s) (not shown). The processor 112 may further control conditioning processes in a conditioner 110.

As used herein, the print zone 108 is a region of the printing device 100 that includes components to deposit ink to the duplex page 102. The print zone 108 may include a number of printheads.

The processor 112 may communicate with a data store 114. The data store 114 may be a machine-readable storage medium. Machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like. The data store 114 may be referred to as memory.

The data store 114 may include data pertaining to the duplex page 102. For example, the data store 114 may store data pertaining to images to be printed on a first printed side 104 and a second printed side 106 of the duplex page 102. As used herein, the first printed side 104 is the side of the duplex page 102 that is printed first. The second printed side 106 is the side of the duplex page 102 that is printed second.

The data store 114 may also store data pertaining to print and conditioning settings for the first printed side 104 and the second printed side 106. For example, each of the first printed side 104 and the second printed side 106 may be associated with a print speed that is based on the ink density for a given side.

As described below, machine-readable storage medium may also be encoded with executable instructions for duplex printing and conditioning based on ink density. For example, the data store 114 may include machine-readable instructions that cause the processor 112 to determine an ink density for the first printed side 104 and an ink density for a second printed side 106 of the duplex page 102. The data store 114 may also include machine-readable instructions that cause the processor 112 to print and condition the duplex page 102 based on a highest ink density of the first printed side 104 and the second printed side 106.

In some cases, moisture from the ink may interact with the media substrate to negatively impact the quality of the media substrate. For example, ink moisture may produce a curled media in addition to creating a soft, soggy feel to the page. The ink moisture may also cause cockling (e.g., wrinkles, puckers, ripples, etc.). Additionally, ink moisture may cause high amounts of friction on a page and may result in a page that is no longer stiff. These ink moisture effects may also result in difficulties when a page is compiled in a finisher (not shown). As used herein, “compile” refers to organizing or grouping a number of printed pages. Finishing operations may also include stacking and/or stapling pages.

In some examples, the print device 100 may include a conditioner 110, which conditions printed pages. An objective of the conditioning by the conditioner 110 is to produce a compilable duplex page 102. For example, the printing device 100 may include a dryer that dries pages after leaving the print zone 108. Other examples of conditioning by the conditioner 110 include tensioning a page, a heated pressure roller (HPR), a calendar roller, coating, uniform steaming then drying, decurling, ironing, air flow, etc. The conditioner 110 may minimize or eliminate curl and cockling. The conditioner 110 may deliver a flat, dry, stiff and low-friction page. In some examples, the conditioned page may be provided to a finisher. In other examples, the conditioned page may be output to an output bin of the print device 100.

Conditioning settings by the conditioner 110 may vary based on the ink density of the first printed side 104 and the second printed side 106 of the duplex page 102. For example, the amount of time that the duplex page 102 stays in a drier may be greater for a high-density ink side than for a low-density ink side. In another example, the amount of tensioning performed after printing a high-density ink side may be greater than tensioning performed after printing a low-density ink side. Tensioning settings may include a tensioning time and/or a tensioning force. Conditioning settings may also include an amount of time that a given side of the duplex page 102 is in the HPR and/or the HPR temperature for a given side. For example, HPR temperature may be increased or decreased based on the ink density.

In some examples, conditioning settings may be based on print speeds. For example, a dryer may immediately begin drying a page that leaves the print zone 108. A high-density ink side may have a slower print speed than a low-density ink side. This may permit a high-density ink side more drying time by the conditioner 110. Therefore, conditioning settings (e.g., drying time and/or tensioning time) may be related to the print settings (e.g., print speed). Altering the print speed may ensure denser ink pages remain constrained in the conditioner 110 longer. The extra drying time associated with the slower print speed may improve or avoid the negative aspects associated with ink moisture.

In other examples, the conditioning settings may be independent of the print settings. For instance, in some cases, conditioning may performed after the duplex page 102 completely exits the print zone 108. In these cases, the conditioning may be unrelated to the print speed.

On a duplex page 102 that has mixed ink densities, print settings and conditioning settings can vary between the first printed side 104 and the second printed side 106. For example, the first printed side 104 may have default print and conditioning settings that are based on the computed ink density of the first printed side 104. The second printed side 106 may have default print and conditioning settings that are based on the computed ink density of the second printed side 106. If the ink density of the first printed side 104 is different than the ink density of the second printed side 106, then the default print and conditioning settings of the first printed side 104 may differ from the default print and conditioning settings of the second printed side 106. Even though lower-ink pages may use less time for conditioning (e.g., drying, tensioning, stabilization, etc.), lower-ink pages can print and be conditioned at slower speeds without negatively impacting the media quality.

The printing device 100 may determine print and conditioning settings for the duplex page 102 based on a highest ink density of the first printed side 104 and the second printed side 106. Therefore, instead of applying the default print and conditioning settings when printing a given side of the duplex page 102, the printing device 100 print and condition both sides based on which side has the highest ink density. In other words, the printing device 100 may track the ink density of both the first printed side 104 and the second printed side 106 to determine print and conditioning settings for both sides of the duplex page 102.

The processor 112 may determine the ink density for the first printed side 104 and the ink density for the second printed side 106 of the duplex page 102. The processor 112 may determine the ink densities before printing begins on the duplex page 102. In other words, the processor 112 may determine the ink density for the first printed side 104 and the ink density for the second printed side 106 before starting to print the first printed side 104.

In some examples, the processor 112 may determine (e.g., calculate) the ink density for a given side based on an ink density score (also referred to as a weighted ink density) for the given side. For example, the processor 112 may determine an ink density score for the first printed side 104 based on an ink amount (e.g., the amount of ink used) and ink location (e.g., where the ink lands) on the first printed side 104. The processor 112 may determine the ink density score for the second printed side 106 based on the ink amount and ink location on the second printed side 106. The ink density of a given side may be calculated based on the image data for the given side. The ink density score indicates a weighted ink density for a given side of the duplex page 102. It should be noted that the ink density for a given side may be represented by its ink density score.

In some examples, the processor 112 may determine the ink density for the first printed side 104 and the ink density for the second printed side 106 in response to determining that a page to be printed is a duplex page 102. For example, if a page is a simplex page, then the processor 112 may print the page using default simplex print and conditioning settings. However, if the processor 112 determines that the page is a duplex page 102, then the processor 112 may calculate the ink densities of the first printed side 104 and the second printed side 106 before printing the duplex page 102.

Upon determining the ink densities, the processor 112 may compare the ink density for the first printed side 104 and the ink density for the second printed side 106. For example, the processor 112 may determine whether the ink density score of the first printed side 104 is greater than the ink density score of the second printed side 106.

If the ink density for the first printed side 104 is greater than the ink density for the second printed side 106, then the processor 112 may cause the second printed side 106 to be printed and conditioned using the print and conditioning settings of the first printed side 104. Because the ink densities differ, the print and conditioning settings of the first printed side may differ from the print and conditioning settings of the second printed side 106. In this case, the processor 112 may use the print and conditioning settings of the first printed side 104 to print and condition the second printed side 106 instead of using the default print and conditioning settings of the second printed side 106.

In an example, the second printed side 106 may be printed using a print speed of the first printed side 104 instead of the default print speed of the second printed side 106. The second printed side 106 may be printed using a print speed of the first printed side 104 that is slower than the print speed of the second printed side 106. In another example, the second printed side 106 may be conditioned by a dryer using a drying time of the first printed side 104 that is greater (e.g., longer) than the drying time of the second printed side 106.

If the ink density for the first printed side 104 is less than or equal to the ink density for the second printed side 106, then the processor 112 may cause the second printed side 106 to be printed and conditioned using the print and conditioning settings of the second printed side 106. In this case, the processor 112 may use the default print and conditioning settings of the second printed side 106 to print and condition the second printed side 106. If the second printed side 106 has a greater ink density, then the first printed side 104 may be printed and conditioned with its default print and conditioning settings. The second printed side 106 may then be printed and conditioned with its default print and conditioning settings to provide extra conditioning (e.g., drying) for the second printed side 106.

The processor 112 may cause the first printed side 104 to be printed and conditioned using the print and conditioning settings of the first printed side 104. For instance, upon determining the print and conditioning settings for the second printed side 106 based on the highest ink density of a duplex page 102, the processor 112 may cause the first printed side 104 to be printed and conditioned using the default print and conditioning settings of the first printed side 104. After printing the first printed side 104, the processor 112 may cause the second printed side 106 to be printed and conditioned using the determined print and conditioning settings, as described above.

In some examples, in addition to printing and conditioning the duplex page 102 based on the highest ink density, the processor 112 may also adjust finishing settings based on the highest ink density. For example, the processor 112 may cause the printing device 100 to perform more aggressive compiling (e.g., page paddling and tamping) for high-ink density pages. In some examples, the processor 112 may determine the highest ink density of the first printed side 104 or the second printed side 106. The processor 112 may then adjust the finishing settings based on the highest ink density.

The printing device 100 may include additional components (not shown). Further, some of the components described herein may be removed and/or modified without departing from the scope of this disclosure. The printing device 100 as depicted in FIG. 1 may not be drawn to scale and may have a different size and/or configuration than shown. In another example, the printing device 100 may use any of a number of printing techniques where moisture is added to the page. For example, the printing device 100 may be an inkjet printer.

In addition, the apparatuses disclosed herein for duplex printing and conditioning based on ink density may be external to the printing device 100. For instance, the apparatuses disclosed herein may be computing device(s) that are external to the printing device 100. The external computing device(s) may determine the print and conditioning settings based on the highest ink density of a duplex page 102. The disclosed apparatuses may communicate the determined print and conditioning settings to the printing device 100.

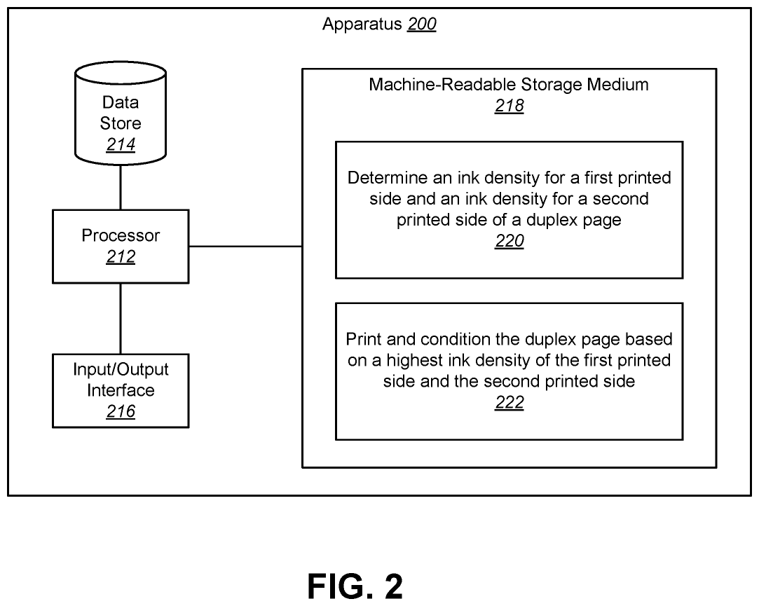

FIG. 2 is a block diagram of an example of an apparatus 200 that may be used in an example of a method for duplex printing and conditioning based on ink density. The apparatus 200 may be a computing device, such as a personal computer, a server computer, a printer, a smartphone, a tablet computer, etc. In an example, the apparatus 200 may be equivalent to the processor 112 depicted in FIG. 1. The apparatus 200 may include a processor 212, a data store 214, an input/output interface 216, and a machine-readable storage medium 218. The apparatus 200 may further include additional components (not shown) and some of the components described herein may be removed and/or modified without departing from the scope of this disclosure.

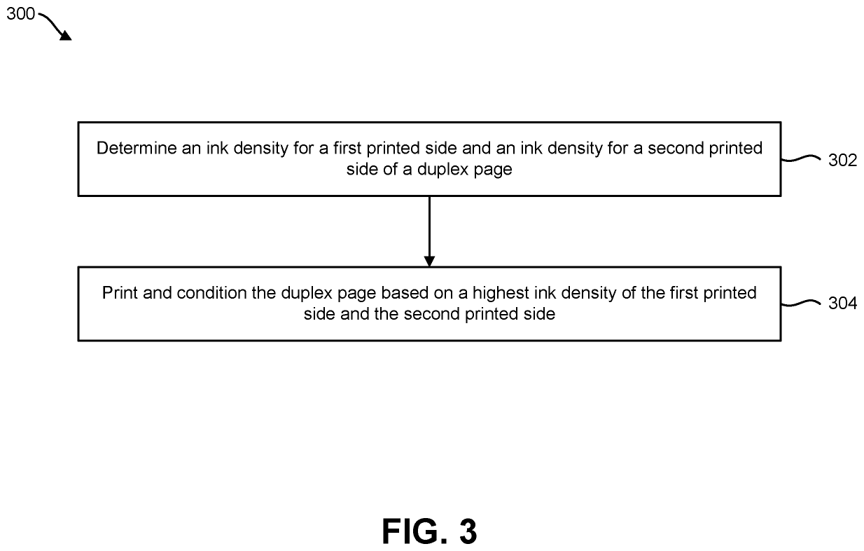

The processor 212 may be any of a central processing unit (CPU), a semiconductor-based microprocessor, GPU, FPGA, an application-specific integrated circuit (ASIC), and/or other hardware devices suitable for retrieval and execution of instructions stored in the machine-readable storage medium 218. The processor 212 may fetch, decode, and execute instructions, such as instructions 220-222 stored on the machine-readable storage medium 218, to control processes to determine 220 an ink density for a first printed side and an ink density for a second printed side of a duplex page; and print and condition 222 the duplex page based on a highest ink density of the first printed side and the second printed side. As an alternative or in addition to retrieving and executing instructions, the processor 212 may include an electronic circuit and/or electronic circuits that include electronic components for performing the functionalities of the instructions 220-222. These processes are described in detail below with respect to FIGS. 3-6.

The machine-readable storage medium 218 may be any electronic, magnetic, optical, or other physical storage device that contains or stores executable instructions. Thus, the machine-readable storage medium 218 may be, for example, RAM, EEPROM, a storage device, an optical disc, and the like. In some implementations, the machine-readable storage medium 218 may be a non-transitory machine-readable storage medium, where the term “non-transitory” does not encompass transitory propagating signals.

The apparatus 200 may also include a data store 214 on which the processor 212 may store information, such as information pertaining to the images to be printed. The data store 214 may be volatile and/or non-volatile memory, such as DRAM, EEPROM, MRAM, phase change RAM (PCRAM), memristor, flash memory, and the like.

The apparatus 200 may further include an input/output interface 216 through which the processor 212 may communicate with an external device(s) (not shown), for instance, to receive and store the information pertaining to the images to be printed. The input/output interface 216 may include hardware and/or machine-readable instructions to enable the processor 212 to communicate with the external device(s). The input/output interface 216 may enable a wired or wireless connection to the external device(s). The input/output interface 216 may further include a network interface card and/or may also include hardware and/or machine-readable instructions to enable the processor 212 to communicate with various input and/or output devices, such as a keyboard, a mouse, a display, another computing device, etc., through which a user may input instructions into the apparatus 200.

FIG. 3 is a flow diagram illustrating an example of a method 300 for duplex printing and conditioning based on ink density. The method 300 for duplex printing and conditioning based on ink density may be performed by, for example, the processor 112 and/or the apparatus 200.

The apparatus may determine 302 an ink density for a first printed side 104 and an ink density for a second printed side 106 of a duplex page 102. For example, the apparatus may determine the ink density score for the first printed side 104 based on an ink amount and ink location on the first printed side 104. The apparatus may determine the ink density score for the second printed side 106 based on an ink amount and ink location on the second printed side 106. Determining 302 the ink density for the first printed side 104 and the ink density for the second printed side 106 may occur before printing the first printed side 104.

The apparatus may print and condition 304 the duplex page 102 based on the highest ink density of the first printed side 104 and the second printed side 106. Conditioning the duplex page 102 may include drying the duplex page 102 with a dryer, tensioning the duplex page 102, processing by the HPR and/or processing by a calendar roller.

In an example, the apparatus may compare the ink density for the first printed side 104 and the ink density for the second printed side 106. For example, the processor 112 may determine whether the ink density score of the first printed side 104 is greater than the ink density score of the second printed side 106.

If the ink density for the first printed side 104 is greater than the ink density for the second printed side 106, then the second printed side 106 may be printed and conditioned 304 using the print and conditioning settings of the first printed side 104. For example, the second printed side 106 may be printed using a print speed of the first printed side 104 that is slower than the print speed (e.g., default print speed) of the second printed side 106. In another example, the second printed side 106 may be conditioned by a dryer using a drying time of the first printed side 104 that is greater than a drying time (e.g., default drying time) of the second printed side 106. In yet another example, the second printed side 106 may be processed by an HPR using an HPR time of the first printed side 104 that is greater than the HPR time (e.g., default HPR time) of the second printed side 106.

If the ink density for the first printed side 104 is less than or equal to the ink density for the second printed side 106, then the second printed side 106 may be printed and conditioned 304 using the print and conditioning settings of the second printed side 106. For example, if the ink density for the second printed side 106 is greater than the ink density of the first printed side 104, then the second printed side 106 may be printed and conditioned 304 using the default print and conditioning settings of the second printed side 106.

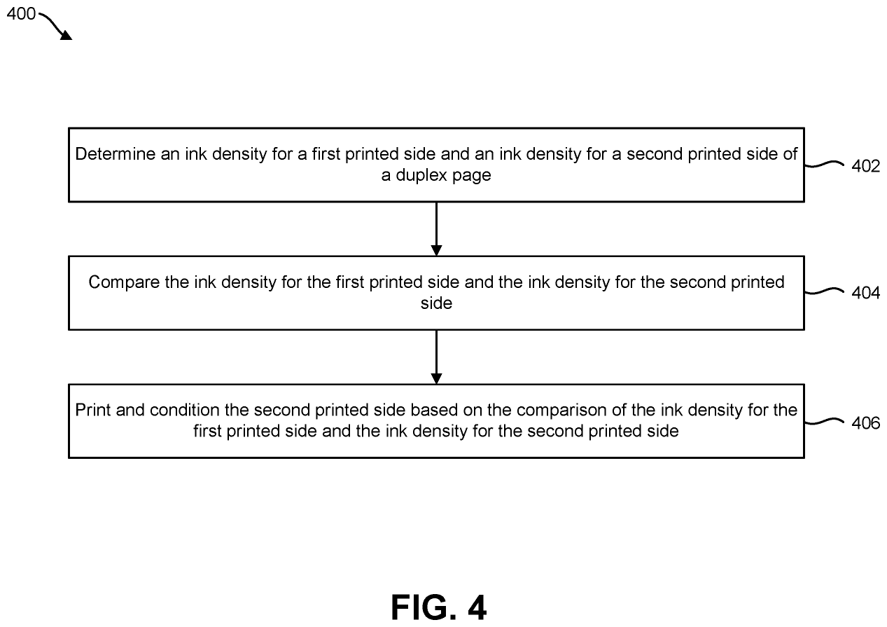

FIG. 4 is a flow diagram illustrating another example of a method 400 for duplex printing and conditioning based on ink density. The method 400 for duplex printing and conditioning based on ink density may be performed by, for example, the processor 112 and/or the apparatus 200.

The apparatus may determine 402 the ink density for a first printed side 104 and the ink density for a second printed side 106 of a duplex page 102. For example, this may be accomplished as described in connection with FIG. 3. The apparatus may determine 402 the ink density for the first printed side 104 and the ink density for the second printed side 106 in response to determining that a page to be printed is a duplex page 102.

The apparatus may compare 404 the ink density for the first printed side 104 and the ink density for the second printed side 106. For example, the apparatus may determine whether the ink density score for the first printed side 104 is greater than the ink density score for the second printed side 106.

The apparatus may print and condition 406 the second printed side 106 based on the comparison of the ink density for the first printed side 104 and the ink density for the second printed side 106. For example, the apparatus may print the first printed side 104 using the default print and conditioning settings for the first printed side 104. Then, if the apparatus determines that the ink density for the first printed side 104 is greater than the ink density for the second printed side 106, the apparatus may print and condition 406 the second printed side 106 using the print and conditioning settings of the first printed side 104. If the ink density for the first printed side 104 is less than or equal to the ink density for the second printed side 106, then the apparatus may print and condition 406 the second printed side 106 using the print and conditioning settings of the second printed side 106.

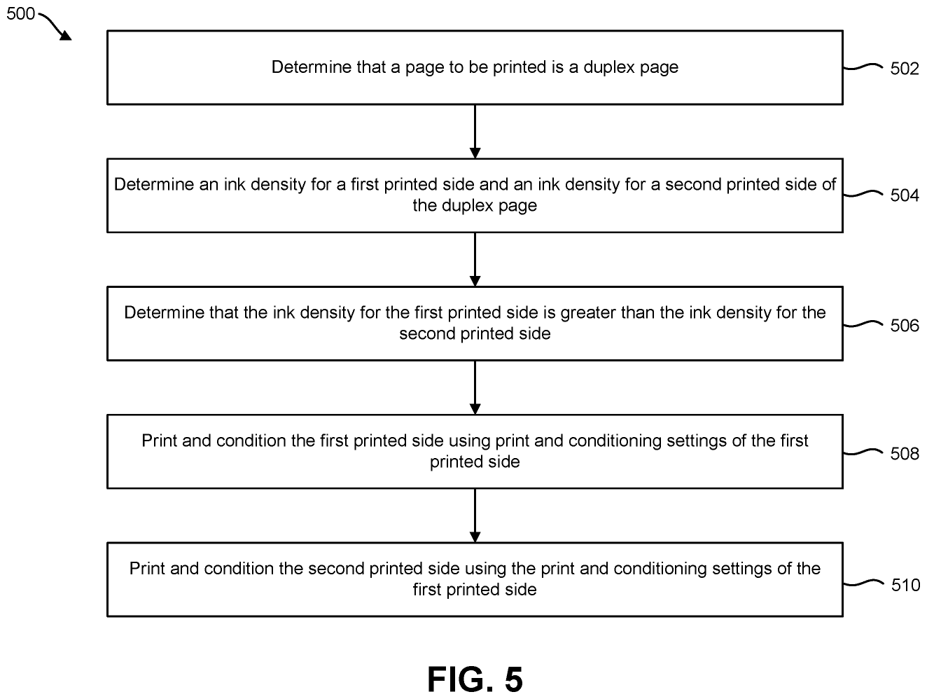

FIG. 5 is a flow diagram illustrating another example of a method 500 for duplex printing and conditioning based on ink density. The method 500 for duplex printing and conditioning based on ink density may be performed by, for example, the processor 112 and/or the apparatus 200.

The apparatus may determine 502 that a page to be printed is a duplex page 102. For example, before printing a page, the apparatus may determine 502 that the page is to be printed with a first printed side 104 and a second printed side 106.

The apparatus may determine 504 the ink density for a first printed side 104 and the ink density for a second printed side 106 of the duplex page 102. For example, this may be accomplished as described in connection with FIG. 3. Determining 504 the ink density for the first printed side 104 and the ink density for the second printed side 106 may occur before printing the first printed side 104.

The apparatus may determine 506 that the ink density for the first printed side 104 is greater than the ink density for the second printed side 106. The apparatus may print and condition 508 the first printed side 104 using the print and conditioning settings for the first printed side 104. These print and conditioning settings may be the default print and conditioning settings for the first printed side 104.

The apparatus may print and condition 510 the second printed side 106 using the print and conditioning settings of the first printed side 104. For example, instead of using the default settings of the second printed side 106, the apparatus may instead use the print and conditioning settings of the first printed side 104 to print and condition 510 the second printed side 106. In an example, the second printed side 106 may be printed using a print speed of the first printed side 104 that is slower than the default print speed of the second printed side 106. In another example, the second printed side 106 may be conditioned by a dryer using a drying time of the first printed side 104 that is greater (e.g., longer) than the default drying time of the second printed side 106.

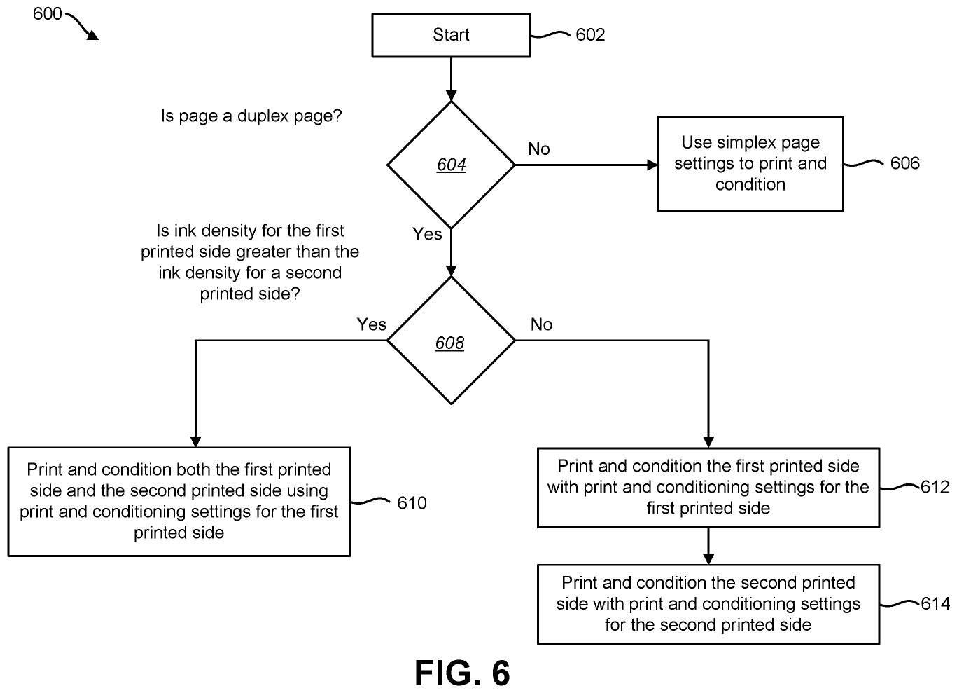

FIG. 6 is a flow diagram illustrating another example of a method 600 for duplex printing and conditioning based on ink density. The method 600 for duplex printing and conditioning based on ink density may be performed by, for example, the processor 112 and/or the apparatus 200.

The method 600 may start 602 in response to the start of printing a page. Before printing the page, the apparatus may determine 604 whether the page is a duplex page 102. If the page is not a duplex page 102, then the apparatus may use 606 simplex page settings to print and condition the page.

If the apparatus determines 604 that the page is a duplex page 102, then the apparatus may determine 608 whether the ink density for the first printed side 104 is greater than the ink density for the second printed side 106. For example, the apparatus may determine the ink density of the first printed side 104 and the ink density of the second printed side 106 of the duplex page 102. The apparatus may then compare the ink density of the first printed side 104 and the ink density of the second printed side 106. For example, the apparatus may determine whether the ink density score for the first printed side 104 is greater than the ink density score for the second printed side 106.

If the apparatus determines 608 that the ink density for the first printed side 104 is greater than the ink density for the second printed side 106, then the apparatus may print and condition 610 both the first printed side 104 and the second printed side 106 using the print and conditioning settings of the first printed side 104. Instead of using the default settings of the second printed side 106, the apparatus may use the print and conditioning settings of the first printed side 104 to print and condition 610 the second printed side 106.

If the apparatus determines 608 that the ink density for the first printed side 104 is not greater than the ink density for the second printed side 106, then the apparatus may print and condition 612 the first printed side 104 using the print and conditioning settings of the first printed side 104 (e.g., the default print and conditioning settings of the first printed side 104). The apparatus may then print and condition 614 the second printed side 106 using the print and conditioning settings of the second printed side 106 (e.g., the default print and conditioning settings of the second printed side 106).

1. A method, comprising:
determining an ink density for a first printed side and an ink density for a second printed side of a duplex page; and
printing and conditioning the duplex page based on a highest ink density of the first printed side and the second printed side.

2. The method of claim 1, wherein determining the ink density for the first printed side and the ink density for the second printed side occurs before printing the first printed side.

3. The method of claim 1, further comprising comparing the ink density for the first printed side and the ink density for the second printed side.

4. The method of claim 1, wherein the second printed side is printed and conditioned using print and conditioning settings of the first printed side in response to determining that the ink density for the first printed side is greater than the ink density for the second printed side.

5. The method of claim 4, wherein the second printed side is printed using a print speed of the first printed side.

6. The method of claim 4, wherein the print and conditioning settings of the first printed side differ from print and conditioning settings of the second printed side.

7. The method of claim 1, wherein the second printed side is printed and conditioned using print and conditioning settings of the second printed side in response to determining that the ink density for the first printed side is less than or equal to the ink density for the second printed side.

8. The method of claim 1, wherein conditioning the duplex page comprises drying the duplex page with a dryer, tensioning the duplex page, processing the duplex page with a heated pressure roller (HPR) or processing the duplex page with a calendar roller.

9. A computing device, comprising:
a memory;
a processor coupled to the memory, wherein the processor is to:
determine an ink density for a first printed side and an ink density for a second printed side of a duplex page;
compare the ink density for the first printed side and the ink density for the second printed side; and
print and condition the second printed side based on the comparison of the ink density for the first printed side and the ink density for the second printed side.

10. The computing device of claim 9, wherein the processor is to:
determine an ink density score for the first printed side based on an ink amount and ink location on the first printed side; and
determine an ink density score for the second printed side based on an ink amount and ink location on the second printed side.

11. The computing device of claim 9, wherein the processor is to:
determine that the ink density for the first printed side is greater than the ink density for the second printed side; and
print and condition the second printed side using print and conditioning settings of the first printed side.

12. The computing device of claim 9, wherein the processor is to adjust finishing settings based on the highest ink density.

13. A non-transitory machine-readable storage medium encoded with instructions executable by a processor, the machine-readable storage medium comprising:
instructions to determine that a page to be printed is a duplex page;
instructions to determine an ink density for a first printed side and an ink density for a second printed side of the duplex page;
instructions to determine that the ink density for the first printed side is greater than the ink density for the second printed side;
instructions to print and condition the first printed side using print and conditioning settings of the first printed side; and
instructions to print and condition the second printed side using the print and conditioning settings of the first printed side.

14. The machine-readable storage medium of claim 13, wherein the second printed side is printed using a print speed of the first printed side that is slower than a print speed of the second printed side.

15. The machine-readable storage medium of claim 13, wherein the second printed side is conditioned by a dryer using a drying time of the first printed side that is greater than a drying time of the second printed side.
